(19) United States
(12) Patent Application Publication
(10) Pub. No.: US 2024/0412154 A1
(43) Pub. Date: Dec. 12, 2024

(54) TRAVEL MANAGEMENT METHOD, TRAVEL MANAGEMENT APPARATUS, AND NON-TRANSITORY PROCESSOR-READABLE MEDIUM STORING A COMPUTER PROGRAM

(71) Applicant: SUMITOMO ELECTRIC INDUSTRIES, LTD., Osaka-shi, Osaka (JP)

(72) Inventors: Yui TSUYUMINE, Osaka-shi (JP); Yu URATA, Osaka-shi (JP)

(73) Assignee: SUMITOMO ELECTRIC INDUSTRIES, LTD., Osaka-shi, Osaka (JP)

(21) Appl. No.: 18/699,782

(22) PCT Filed: Jul. 14, 2022
(86) PCT No.: PCT/JP2022/027654

§ 371 Date: Apr. 9, 2024

(30) Foreign Application Priority Data
Nov. 2, 2021 (JP) 2021-179257

(51) Int. Cl. G06Q 10/0833

(52) U.S. Cl. CPC G06Q 10/0833

(57) ABSTRACT

A travel management method includes acquiring travel plan information of a vehicle for a plurality of locations; acquiring travel result information of the vehicle for the plurality of locations; and causing, based on the travel plan information and the travel result information, a display device to display, in association with a time axis, a travel plan of the vehicle in a time period including times before and after a predetermined time and a travel result of the vehicle by the predetermined time.

### TECHNICAL FIELD

The present disclosure relates to a travel management method, a travel management apparatus, and a computer program. This application claims priority based on Japanese Patent Application No. 2021-179257 filed on Nov. 2, 2021, and the entire contents of the Japanese patent application are incorporated herein by reference.

### BACKGROUND ART

PTL 1 discloses a technique related to delivery support for completing a delivery operation within an allowable time. In PTL 1, a management terminal device is used for delivery support. The management terminal displays the delivery delay time (see FIG. 23 of PTL 1).

### CITATION LIST

### Patent Literature

PTL 1: Japanese Unexamined Patent Application Publication No. 2018-073032

### SUMMARY OF INVENTION

A travel management method according to one aspect of the present disclosure includes acquiring travel plan information of a vehicle for a plurality of locations; acquiring travel result information of the vehicle for a plurality of the locations; and causing, based on the travel plan information and the travel result information, a display device to display, in association with a time axis, a travel plan of the vehicle in a time period including times before and after a predetermined time and a travel result of the vehicle by the predetermined time.

A travel management apparatus according to another aspect of the present disclosure includes a travel management information acquiring unit configured to acquire travel plan information of a vehicle for a plurality of locations; a travel result information acquiring unit configured to acquire travel result information of the vehicle for a plurality of the locations; and a display processing unit configured to cause, based on the travel plan information and the travel result information, a display device to display, in association with a time axis, a travel plan of the vehicle in a time period including times before and after a predetermined time and a travel result of the vehicle by the predetermined time.

A computer program according to another aspect of the present disclosure is a computer program for causing a computer to function as a travel management information acquiring unit configured to acquire travel plan information of a vehicle for a plurality of locations; a travel result information acquiring unit configured to acquire travel result information of the vehicle for a plurality of the locations; and a display processing unit configured to cause, based on the travel plan information and the travel result information, a display device to display, in association with a time axis, a travel plan of the vehicle in a time period including times before and after a predetermined time and a travel result of the vehicle by the predetermined time.

The present disclosure can also be realized as a computer program for causing a computer to execute characteristic steps included in the travel management method. It is needless to say that such a computer program can be distributed via a computer-readable non-transitory recording medium such as a compact disc-read only memory (CD-ROM) or a communication network such as the Internet.

### BRIEF DESCRIPTION OF THE DRAWINGS

FIG. 1 is a diagram for explaining an example of a mechanism of joint delivery.

FIG. 2 is a diagram showing an overall configuration of a travel management system according to an embodiment of the present disclosure.

FIG. 3 is a diagram showing an example of a configuration of a travel management apparatus according to an embodiment of the present disclosure.

FIG. 4 is a diagram showing an example of travel plan information.

FIG. 5 is a diagram showing an example of travel result information.

FIG. 6 is a diagram showing an example of a departure estimated-actual difference calculated by an estimated-actual difference calculating unit.

FIG. 7 is a diagram showing an example of an arrival estimated-actual difference calculated by an estimated-actual difference calculating unit.

FIG. 8 is a diagram showing an example of an image displayed on a display device of a manager terminal.

FIG. 9 is a diagram showing an example of an image displayed on a display device of a manager terminal.

FIG. 10 is a diagram showing an estimated-actual management diagram shown in FIG. 9.

FIG. 11 is a diagram showing a correspondence of a location node to a departure marker and an arrival marker.

FIG. 12 is a diagram showing a display form of a departure estimated-actual difference and arrival estimated-actual difference.

FIG. 13 is a diagram showing information for each user displayed on a terminal used by a user.

FIG. 14 is a diagram showing an example of an image displayed on a driver terminal.

FIG. 15 is a diagram showing an example of an image displayed on a sender-side-owner terminal used by a sender-side-owner “A1”.

FIG. 16 is a flowchart showing a procedure of a vehicle travel management processing executed by a travel management apparatus.

### DETAILED DESCRIPTION

### Problems to be Solved by Present Disclosure

In a vehicle travel management, it is important to easily recognize how much a delay actually occurred in the past will affect a subsequent travel plan. Thus, for example, at the time when it is found that delivery work cannot be completed according to the travel plan, it is possible to take measures such as contacting a destination or changing a travel route.

However, in the display method described in PTL 1, although it is possible to recognize the delay time to the destination as a numerical value, it is difficult to recognize the degree of influence of the delay on the future travel plan. Therefore, it is difficult to judge whether the travel plan can be implemented.

The present disclosure has been made in view of the above circumstances, and an object of the present disclosure is to provide a travel management method, a travel management apparatus, and a computer program that enable a user to easily recognize the degree of influence on a future travel plan by an arrival or departure delay at a location.

### Advantageous Effects of Present Disclosure

According to the present disclosure, it is possible to easily recognize the degree of influence of the arrival or departure delay at the location on the future travel plan.

### Overview of Embodiments of Present Disclosure

First, an overview of embodiments of the present disclosure will be listed and described.

(1) A travel management method according to an embodiment of the present disclosure includes acquiring travel plan information of a vehicle for a plurality of locations; acquiring travel result information of the vehicle for a plurality of the locations; and causing, based on the travel plan information and the travel result information, a display device to display, in association with a time axis, a travel plan of the vehicle in a time period including times before and after a predetermined time and a travel result of the vehicle by the predetermined time.

According to this configuration, the travel plan and the travel result are displayed on the display device in association with the time axis. Thus, the user who sees the screen of the display device can intuitively recognize the magnitude of the delay time from the travel plan, compared to the case where the time difference is displayed as a numerical value as in PTL 1. Further, a future travel plan is also displayed. For example, the user can intuitively recognize that an influence on the future travel plan is large when the delay time is large. Thus, the user can easily recognize the degree of influence of the arrival or departure delay at the location on the future travel plan by the display on the display device.

(2) The causing may include causing to display, in association with the time axis, information indicating a change of order in which a plurality of the locations are visited.

According to this configuration, the user can easily recognize the change of order in which the plurality of locations is visited. Thus, the user can easily identify the cause of the arrival or departure delay at the location.

(3) The travel management method may further include generating, based on the travel plan information and the travel result information, an arrival estimated-actual difference which is a difference between an estimated arrival time and an actual arrival time of the vehicle at each of the locations. The causing may include causing to display image information indicating the arrival estimated-actual difference.

According to this configuration, the user can visually recognize the arrival estimated-actual difference.

(4) The travel management method may further include generating, based on the travel plan information and the travel result information, a departure estimated-actual difference which is a difference between an estimated departure time and an actual departure time of the vehicle at each of the locations. The causing may include causing to display image information indicating the departure estimated-actual difference.

According to this configuration, the user can visually recognize the departure estimated-actual difference.

(5) The causing may include causing the display device, the display device being used by an owner of a package transported by the vehicle, to display the travel plan and the travel result for the location which is a destination of a package related to the owner, and not to display the travel plan and the travel result for the location which is a destination of a package unrelated to the owner.

According to this configuration, it is possible to prevent the sender-side-owner of the package from viewing the travel plan and the travel result related to the package that is not delivered from the sender-side-owner. In addition, it is possible to prevent the receiver-side-owner of the package from viewing the travel plan and the travel result related to the package that is not delivered to the receiver-side-owner. Therefore, privacy or personal information of a user other than the sender-side-owner or privacy or personal information of a user other than the receiver-side-owner can be protected.

(6) The causing may include causing the display device, the display device being used by a manager of the vehicle, to display identification information of the vehicle in association with a display position of at least one of the travel plans or the travel results.

According to this configuration, the manager can accurately recognize the degree of influence of the arrival or departure delay at the location on the future travel plan for each vehicle.

(7) The predetermined time may be a current time.

According to this configuration, the displaying is performed in consideration of the travel result up to the current time. Therefore, the user can easily recognize the degree of influence of the arrival or departure delay at the location on the future travel plan in real time.

(8) The causing may include causing to display the travel plan for completing travel of the vehicle to a plurality of the locations.

According to this configuration, the user can intuitively recognize the degree of influence of the arrival or departure delay at the location on the completion of the travel plan, and can easily determine whether or not the travel plan can be realized.

(9) A travel management apparatus according to another aspect of the present disclosure includes a travel management information acquiring unit configured to acquire travel plan information of a vehicle for a plurality of locations; a travel result information acquiring unit configured to acquire travel result information of the vehicle for a plurality of the locations; and a display processing unit configured to cause, based on the travel plan information and the travel result information, a display device to display, in association with a time axis, a travel plan of the vehicle in a time period including times before and after a predetermined time and a travel result of the vehicle by the predetermined time.

This configuration includes processing units corresponding to the characteristic steps in the travel management method described above. Therefore, the operations and effects similar to those of the travel management method described above can be achieved.

(10) A computer program according to another aspect of the present disclosure is a computer program for causing a computer to function as: a travel management information acquiring unit configured to acquire travel plan information of a vehicle for a plurality of locations; a travel result information acquiring unit configured to acquire travel result information of the vehicle for a plurality of the locations; and a display processing unit configured to cause, based on the travel plan information and the travel result information, a display device to display, in association with a time axis, a travel plan of the vehicle in a time period including times before and after a predetermined time and a travel result of the vehicle by the predetermined time.

According to this configuration, the computer can be caused to function as the travel management apparatus described above. Therefore, the operations and effects similar to those of the travel management apparatus described above can be achieved.

### Details of Embodiments of Present Disclosure

Hereinafter, embodiments of the present disclosure will be described with reference to the drawings. The embodiments described below are all specific examples of the present disclosure. Numerical values, shapes, materials, components, the arrangement and connection of the components, steps, the order of the steps, and the like shown in the following embodiments are mere examples, and do not limit the present disclosure. Further, among the components in the following embodiments, components not recited in the independent claims are components that can be arbitrarily added. Each drawing is a schematic view and is not necessarily illustrated strictly.

The same components are denoted by the same reference numerals. The functions and names of these components are the same, and thus the description thereof will be omitted as appropriate. In an embodiment of the present disclosure, a travel management system of a vehicle for joint delivery of packages will be described.

### [About Joint Delivery]

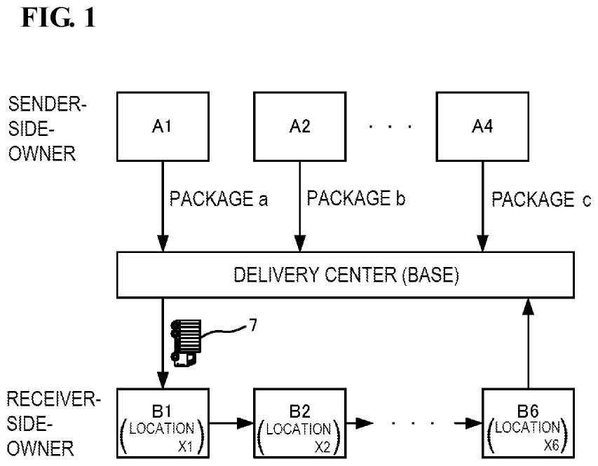

FIG. 1 is a diagram for explaining an example of a mechanism of joint delivery. The joint delivery is a mechanism in which a plurality of packages requested to be delivered from a plurality of sender-side-owners respectively are mixed in the same vehicle and delivered to destinations of receiver-side-owners of the respective packages.

Referring to FIG. 1, for example, a sender-side-owner A1 requests the delivery of a package a to a receiver-side-owner B1 located at a location X1. A sender-side-owner A2 requests the delivery of a package b to a receiver-side-owner B2 located at a location X2. A sender-side-owner A4 requests the delivery of a package c to a receiver-side-owner B6 located at a location X6.

Packages a, b, and c are collected from respective sender-side-owners A1, A2, and A4 to a delivery center which is a delivery base. The collection may be performed by a vehicle managed by the delivery center or by vehicles managed by sender-side-owners A1, A2, and A4.

A vehicle 7 is mixedly loaded with the packages to be delivered including packages a, b, and c at the delivery center, moves from the delivery center to location X1, and delivers package a to receiver-side-owner B1 at location X1. Thereafter, vehicle 7 moves to location X2, and delivers package b to receiver-side-owner B2 at location X2. Similarly, vehicle 7 moves to location X6 and delivers package c to receiver-side-owner B6 at location X6. After the scheduled delivery of the packages is completed, vehicle 7 returns to the delivery center. The number of sender-side-owners and receiver-side-owners is not limited to three, and may be other values.

### [Overall Configuration of Travel Management System]

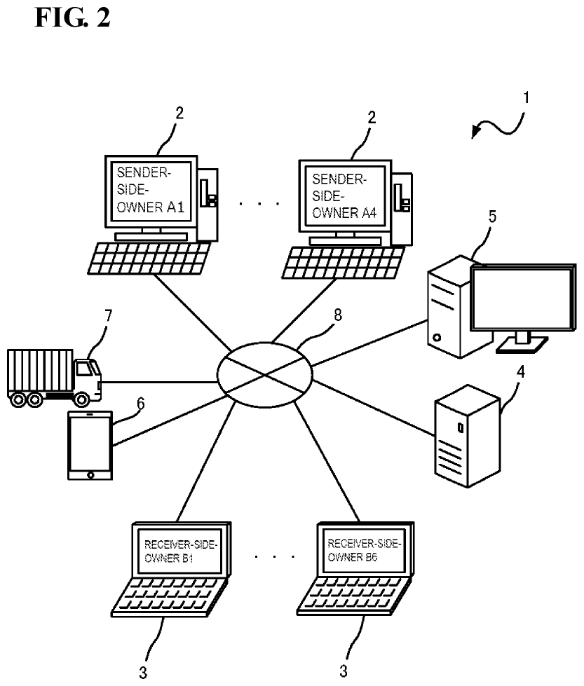

FIG. 2 is a diagram showing the overall configuration of a travel management system according to an embodiment of the present disclosure. Referring to FIG. 2, a travel management system 1 is a system for managing a travel of a vehicle for the joint delivery of packages, and includes a plurality of sender-side-owner terminals 2, a plurality of receiver-side-owner terminals 3, a travel management apparatus 4, a manager terminal 5, a driver terminal 6, and vehicle 7.

Vehicle 7 is a delivery vehicle such as a truck or a van on which packages for a plurality of receiver-side-owners are loaded and which delivers the packages to the respective receiver-side-owners. Vehicle 7 includes a position determination unit that determines the position of vehicle 7. The position determination unit determines the position of vehicle 7 by using satellite navigation. For example, the position determination unit determines the position of vehicle 7 based on radio waves received from a plurality of global positioning system (GPS) satellites. The position of vehicle 7 can be determined by, for example, latitude and longitude. The satellite navigation uses a global navigation satellite system (GNSS) such as GPS, but the global navigation satellite system is not limited to GPS.

Sender-side-owner terminal 2 is a terminal device used by each of sender-side-owners (for example, sender-side-owners A1 to A4 shown in FIG. 1).

Receiver-side-owner terminal 3 is a terminal device used by each of the receiver-side-owners (for example, receiver-side-owners B1 to B6 shown in FIG. 1).

Manager terminal 5 is a terminal device used by an operation manager of vehicle 7 or a manager of packages delivered by vehicle 7 (hereinafter, referred to as a “manager”).

Driver terminal 6 is a terminal device used by the driver of vehicle 7, and is, for example, a smartphone carried by the driver of vehicle 7 or a fellow passenger of vehicle 7. Driver terminal 6 may be an in-vehicle terminal device mounted in vehicle 7 in advance.

Travel management apparatus 4 performs control for displaying the travel status of vehicle 7 on the display screens of sender-side-owner terminals 2, the display screens of receiver-side-owner terminals 3, the display screen of manager terminal 5, and the display screen of driver terminal 6.

Sender-side-owner terminals 2, receiver-side-owner terminals 3, travel management apparatus 4, manager terminal 5, driver terminal 6, and vehicle 7 are connected to a network 8 such as the Internet in a wired or wireless manner, and can transmit and receive data to and from each other.

### [Configuration of Travel Management Apparatus 4]

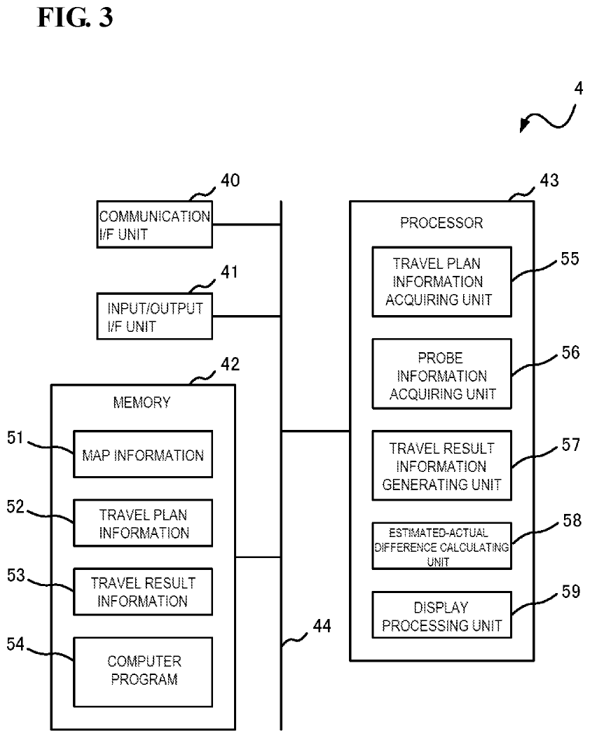

FIG. 3 is a diagram showing an example of a configuration of travel management apparatus 4 according to an embodiment of the present disclosure. Travel management apparatus 4 is configured by a computer, and includes a communication interface (I/F) unit 40, an input/output I/F unit 41, a memory 42, and a processor 43 that are connected to each other via a bus 44.

Communication I/F unit 40 includes a communication module for performing wired or wireless communication with an external device.

Input/output I/F unit 41 includes an interface for connecting an input device such as a keyboard or a mouse and an output device such as a display device to travel management apparatus 4.

Memory 42 is configured by a volatile memory element such as a static RAM (SRAM) or a dynamic RAM (DRAM), a nonvolatile memory element such as a flash memory or an electrically erasable programmable read only memory (EEPROM), a magnetic storage unit such as a hard disk, or the like.

Memory 42 stores a computer program 54 to be executed by processor 43. Memory 42 stores a map information 51, a travel plan information 52, a travel result information 53, and the like used when computer program 54 is executed. Map information 51 is information indicating a map on the route on which vehicle 7 travels. Travel plan information 52 is information indicating the travel plan of vehicle 7. Travel result information 53 is information indicating the travel result of vehicle 7. Memory 42 also stores data generated during execution of computer program 54.

Processor 43 is configured by a CPU (Central Processing Unit) or the like, and includes a travel plan information acquiring unit 55, a probe information acquiring unit 56, a travel result information generating unit 57, an estimated-actual difference calculating unit 58, and a display processing unit 59 as functional processing units realized by executing computer program 54 stored in memory 42.

Travel plan information acquiring unit 55 acquires travel plan information 52 by reading travel plan information 52 from memory 42. When travel plan information 52 is stored in an external device, travel plan information acquiring unit 55 may receive travel plan information 52 from the external device via communication I/F unit 40.

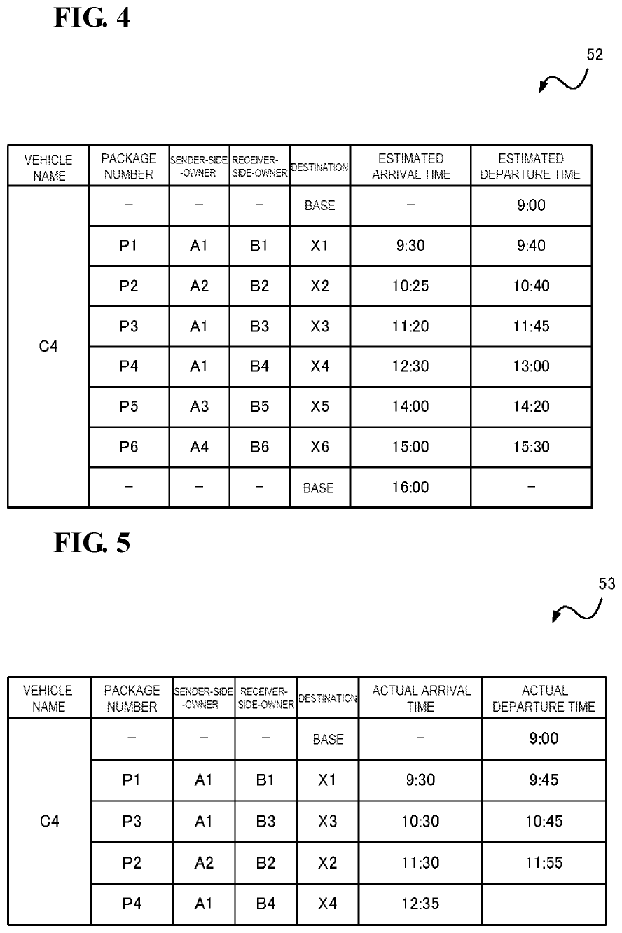

FIG. 4 is a diagram showing an example of travel plan information 52. Vehicle 7 delivers the packages in accordance with travel plan information 52.

Travel plan information 52 includes information of vehicle name, package number, sender-side-owner, receiver-side-owner, destination, estimated arrival time, and estimated departure time. The vehicle name represents the identification name of vehicle 7 used for delivery of the packages. The package number represents a number for identifying a package or a set of packages to be delivered to a destination. The sender-side-owner represents a client who has requested the delivery of the package. The receiver-side-owner represents the receiver of the package. The destination represents the name of the destination of the package. Here, the destination “base” indicates “delivery center” which is the delivery base of the packages.

Travel plan information 52 shown in FIG. 4 indicates the travel plan of vehicle 7 having the vehicle name “C4”. For example, vehicle 7 is scheduled to depart from “base” at “9:00”. In addition, vehicle 7 is scheduled to arrive at the destination “X1” at “9:30” in order to deliver the package of the package number “P1” requested from the sender-side-owner “A1” to the receiver-side-owner “B1”, and to depart from the destination “X1” at “9:40”. In addition, vehicle 7 is scheduled to arrive at the destination “X2” at “10:25” in order to deliver the package of the package number “P2” requested from the sender-side-owner “A2” to the receiver-side-owner “B2”, and to depart from the destination “X2” at “10:40”. Vehicle 7 is scheduled to deliver packages with package numbers “P3” to “P6” in the same manner. After the package number “P6” is delivered, vehicle 7 is scheduled to arrive at “base” at “16:00”.

Referring again to FIG. 3, probe information acquiring unit 56 acquires probe information of vehicle 7 by receiving the probe information indicating the position of vehicle 7 and the time at which vehicle 7 is present at the position from vehicle 7 via communication I/F unit 40. Probe information acquiring unit 56 may receive the probe information of vehicle 7 from another device instead of receiving the probe information directly from vehicle 7.

Travel result information generating unit 57 generates travel result information 53 indicating the travel result of vehicle 7 based on the travel plan information acquired by travel plan information acquiring unit 55 and the probe information acquired by probe information acquiring unit 56. That is, travel result information generating unit 57 determines, based on the probe information, the actual arrival time and the actual departure time of vehicle 7 to the destination indicated in the travel plan information.

The position (for example, latitude and longitude) of each destination is determined in advance. An area within a radius of D m from the position of each destination is set as a geofence.

Travel result information generating unit 57 determines, for each destination, the time at which the traveling speed firstly becomes 0 in the geofence of the destination as the actual arrival time to the destination, and determines the travel time at which the traveling speed lastly becomes 0 in the geofence as the actual departure time from the destination. Here, the traveling speed is calculated based on the probe information. When the probe information includes information on the traveling speed, the information may be used. The shape of the geofence is not limited to a circle, and may be another shape such as an ellipse or a polygon.

Travel result information generating unit 57 extracts, from travel plan information 52, the package number, sender-side-owner, and receiver-side-owner corresponding to the destination where vehicle 7 has arrived or departed, and sets the extracted package number, sender-side-owner, and receiver-side-owner as a package number, a sender-side-owner, and a receiver-side-owner corresponding to the destination in travel result information 53. Travel result information generating unit 57 stores the generated travel result information 53 in memory 42.

FIG. 5 is a diagram showing an example of travel result information 53. Travel result information 53 includes information of vehicle name, package number, sender-side-owner, receiver-side-owner, destination, actual arrival time, and actual departure time. The vehicle name represents the identification name of vehicle 7 used for the delivery of the packages. The package number represents a number for identifying a package or a set of packages delivered to the destination. The sender-side-owner represents a client who has requested the delivery of the package. The receiver-side-owner represents the receiver of the package. The destination represents the name of the destination of the package. Here, the destination “base” indicates “delivery center” which is the delivery base of the packages.

Travel result information 53 shown in FIG. 5 indicates the travel result of vehicle 7 having the vehicle name “C4”. For example, according to travel result information 53, vehicle 7 departed from “base” at “9:00”. Vehicle 7 arrived at the destination “X1” at “9:30” in order to deliver the package of the package number “P1” requested from the sender-side-owner “A1” to the receiver-side-owner “B1”, and departed from the destination “X1” at “9:45”. Vehicle 7 arrived at the destination “X3” at “10:30” in order to deliver the package of the package number “P3” requested from the sender-side-owner “A1” to the receiver-side-owner “B3”, and departed from the destination “X3” at “10:45”. Vehicle 7 arrived at the destination “X2” at “11:30” in order to deliver the package of the package number “P2” requested from the sender-side-owner “A2” to the receiver-side-owner “B2”, and departed from the destination “X3” at “11:55”. Vehicle 7 arrived at the destination “X4” at “12:35” in order to deliver the package of the package number “P4” requested from the sender-side-owner “A1” to the receiver-side-owner “B4”.

Referring again to FIG. 3, calculating unit 58 acquires travel plan information 52 from travel plan information acquiring unit 55, and reads travel result information 53 stored in memory 42. Estimated-actual difference calculating unit 58 calculates the estimated-actual difference between the travel plan and the travel result of vehicle 7 based on travel plan information 52 and travel result information 53. That is, estimated-actual difference calculating unit 58 calculates a departure estimated-actual difference, which is the difference between the estimated departure time and the actual departure time, for each of the base and locations X1 to X6 which are the destinations included in travel plan information 52. Estimated-actual difference calculating unit 58 calculates a departure estimated-actual difference, which is a difference between the estimated arrival time and the actual arrival time, for each of the base and locations X1 to X6 which are the destinations included in travel plan information 52.

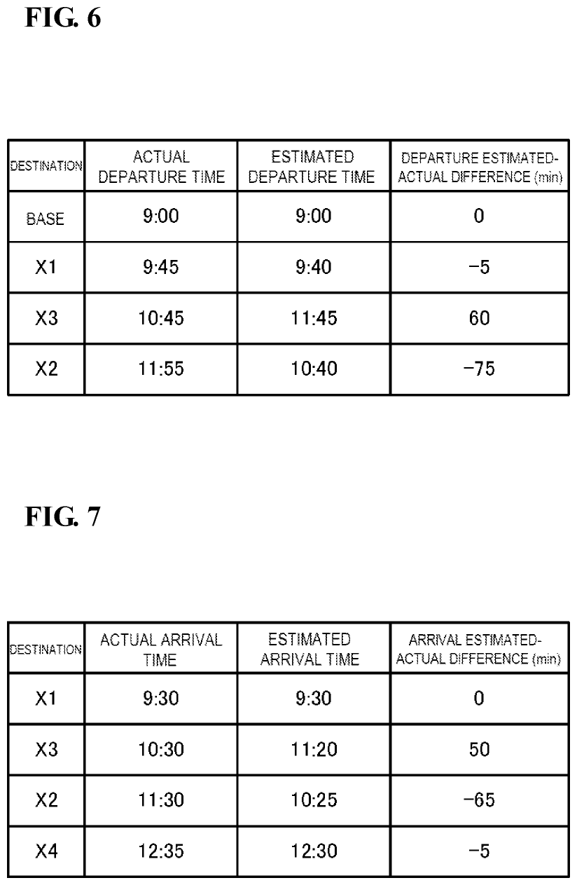

FIG. 6 is a diagram showing an example of the departure estimated-actual difference calculated by estimated-actual difference calculating unit 58. According to travel result information 53 shown in FIG. 5, the actual departure times from the base and locations X1, X3, and X2 are 9:00, 9:45, 10:45, and 11:55, respectively. On the other hand, according to travel plan information 52 shown in FIG. 4, the estimated departure times from the base and locations X1, X3, and X2 are 9:00, 9:40, 11:45, and 10:40, respectively. Therefore, estimated-actual difference calculating unit 58 subtracts the actual departure time from the estimated departure time for each destination, thereby calculating the departure estimated-actual difference at the base and locations X1, X3, and X2 as 0 minutes, −5 minutes, 60 minutes, and −75 minutes, respectively. When the departure estimated-actual difference is a positive value, it indicates that the departure time is earlier than the estimated departure time, and when the departure estimated-actual difference is a negative value, it indicates that the departure time is later than the estimated departure time. At the present time, vehicle 7 has not departed from locations X4, X5, or X6, and the actual departure time has not been determined. Therefore, estimated-actual difference calculating unit 58 does not calculate the departure estimated-actual difference for locations X4, X5, or X6.

FIG. 7 is a diagram showing an example of the arrival estimated-actual difference calculated by estimated-actual difference calculating unit 58. According to travel result information 53 shown in FIG. 5, the actual arrival times at locations X1, X3, X2, and X4 are 9:30, 10:30, 11:30, and 12:35, respectively. On the other hand, according to travel plan information 52 shown in FIG. 4, the estimated arrival times at locations X1, X3, X2, and X4 are 9:30, 11:20, 10:25, and 12:30, respectively. Therefore, estimated-actual difference calculating unit 58 subtracts the actual arrival time from the estimated arrival time for each destination, thereby calculating the arrival estimated-actual differences at locations X1, X3, X2, and X4 as 0 minutes, 50 minutes, −65 minutes, and −5 minutes, respectively. When the arrival estimated-actual difference is a positive value, it indicates that the arrival time is earlier than the estimated arrival time, and when the arrival estimated-actual difference is a negative value, it indicates that the arrival time is later than the estimated arrival time. At the present time, vehicle 7 has not arrived at locations X5 or X6, and the actual arrival time has not been determined. Therefore, estimated-actual difference calculating unit 58 does not calculate the arrival estimated-actual difference for locations X5 or X6.

Display processing unit 59 generates display screen information to be displayed on each of the display devices of sender-side-owner terminal 2, receiver-side-owner terminal 3, manager terminal 5, and driver terminal 6, and transmits the generated display screen information to each terminal via communication I/F unit 40. Each terminal receives the display screen information, generates an image based on the display screen information, and causes the display device of the terminal to display the generated image.

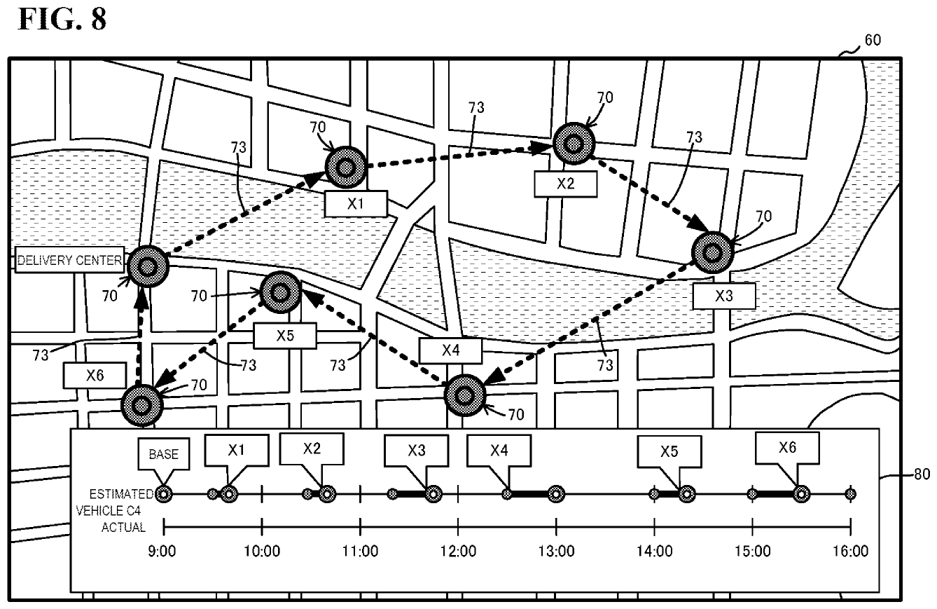

FIG. 8 is a diagram showing an example of an image displayed on the display device of manager terminal 5. The image shown in FIG. 8 is an image displayed before vehicle 7 departs from the base. The image includes a map 60 and an estimated-actual management diagram 80 arranged on map 60. On map 60, a location node 70 and a link 73 of a dashed line connecting between location nodes 70 are shown. Location nodes 70 indicate the positions of the base (delivery center) and locations X1 to X6 indicated in travel plan information 52 on map 60. Links 73 indicate the delivery order indicated in travel plan information 52. That is, it is indicated that vehicle 7 performs delivery in the order of “delivery center→location X1→location X2→location X3→location X4→location X5→location X6→delivery center”.

Estimated-actual management diagram 80 is a diagram showing the travel plan and the travel result on a time axis based on travel plan information 52 and travel result information 53. Estimated-actual management diagram 80 will be described in detail later.

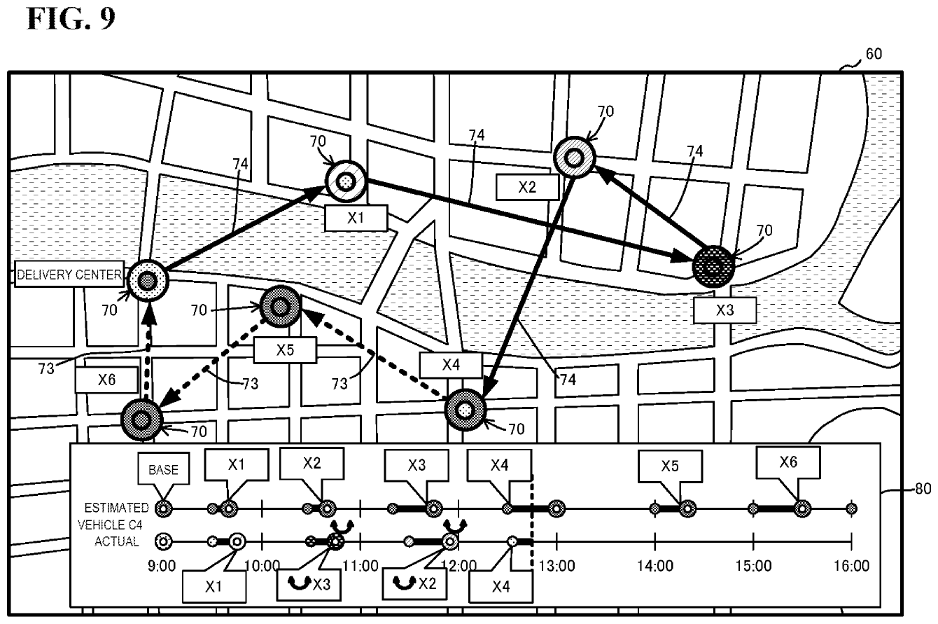

FIG. 9 is a diagram showing an example of an image displayed on the display device of manager terminal 5. The image shown in FIG. 9 is an image displayed after vehicle 7 has departed from the base. The image includes map 60 and estimated-actual management diagram 80 arranged on map 60. On map 60, location node 70, and link 73 of the dashed line and a link 74 of a solid line connecting between location nodes 70 are shown. Location nodes 70 indicate the positions of the base (delivery center) and locations X1 to X6 on map 60, as in the case shown in FIG. 8. However, the display form of each location node 70 is partially different from that shown in FIG. 8. The display form of location node 70 will be described later. Links 74 indicate the delivery order of the packages (order in which the plurality of destinations are visited) indicated in travel result information 53. That is, it is indicated that vehicle 7 has delivered the packages in the order of “delivery center→location X1→location X3→location X2→location X4”. Links 73 indicate the delivery order of packages scheduled to be delivered from now (after a predetermined time described later). That is, it is indicated that vehicle 7 is scheduled to deliver the packages in the order of “location X4→location X5→location X6→delivery center”.

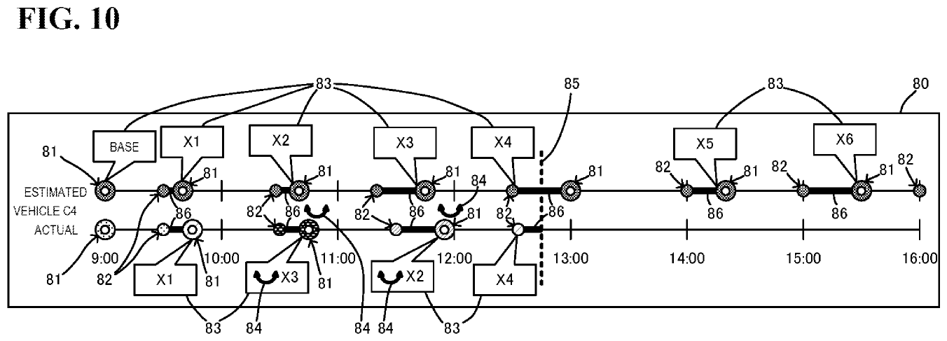

FIG. 10 is a diagram showing estimated-actual management diagram 80 shown in FIG. 9. Estimated-actual management diagram 80 shows, in association with the time axis, the travel plan of vehicle 7 in a time period including times before and after a predetermined time and the travel result of vehicle 7 up to the predetermined time. Here, the predetermined time is a current time, but the predetermined time is not limited to the current time. In addition, in estimated-actual management diagram 80 the travel plan for completing travel of vehicle 7 to the plurality of locations. However, when the entire travel plan cannot be displayed at the same time and only a part of the travel plan can be displayed at the same time, the travel plan until the travel completion may be displayed by the scroll display.

The horizontal direction represents the time axis, and here, the time axis from 9:00 to 16:00 is represented. The upper part shows the travel plan, and the lower part shows the travel result.

In the upper part, departure markers 81, arrival markers 82, and links 86 are shown. Departure marker 81 in the upper part is image information plotted at a position corresponding to the estimated departure time, and arrival marker 82 in the upper part is image information plotted at a position corresponding to the estimated arrival time. Link 86 in the upper part is obtained by connecting arrival marker 82 and departure marker 81 at each location, and the length of link 86 indicates the scheduled stay time at each location. A balloon 83 is displayed near departure marker 81 or arrival marker 82 in the upper part. Balloon 83 indicates the name of the base or the location corresponding to departure marker 81 or arrival marker 82. For example, balloon 83 may not be displayed in a normal state, and balloon 83 may be displayed when the user operates the mouse or the like to select departure marker 81 or arrival marker 82.

In the lower part, as in the upper part, departure markers 81, arrival markers 82, and links 86 are shown. Departure marker 81 in the lower part is plotted at a position corresponding to the actual departure time, and arrival marker 82 in the lower part is plotted at a position corresponding to the actual arrival time. Link 86 in the lower part is obtained by connecting arrival marker 82 and departure marker 81 at each location or by connecting arrival marker 82 and a current time bar 85 indicating the current time, and the length of link 86 indicates the actual stay time at each location. In addition, balloon 83 is displayed near departure marker 81 or arrival marker 82 in the lower part. Balloon 83 indicates the name of the base or the location corresponding to departure marker 81 or arrival marker 82. For example, balloon 83 may not be displayed in a normal state, and balloon 83 may be displayed when the user operates the mouse or the like to select departure marker 81 or arrival marker 82.

In the lower part, a change icon 84 is further displayed. Change icon 84 is a display object (image) indicating that the delivery order of the package has been changed, and is displayed in association with the location where the change has been made. For example, change icon 84 is displayed near departure marker 81 of the location where the change has been made and on balloon 83 corresponding to departure marker 81. Change icon 84 may be displayed only in the vicinity of departure marker 81 or balloon 83, or may be displayed in the vicinity of arrival marker 82 instead of departure marker 81.

According to travel result information 53 shown in FIG. 5, the order in which locations X2 and X3 has been visited is changed from that shown in travel plan information 52. Therefore, change icons 84 are displayed at the positions corresponding to locations X2 and X3 in the lower part.

Current time bar 85 indicating the current time is displayed in estimated-actual management diagram 80. It is understood that the current time is about 12:45 from the display position of current time bar 85. Current time bar 85 moves to the right every time the current time is updated.

The name of the vehicle (C4 in this case) that travels in accordance with travel plan information 52 is shown at the left end of estimated-actual management diagram 80.

In estimated-actual management diagram 80 shown in FIG. 8, only the upper part of estimated-actual management diagram 80 shown in FIG. 10 is displayed, and departure marker 81, arrival marker 82, balloon 83, change icon 84, and link 86 in the lower part, and current time bar 85 are not displayed.

Display processing unit 59 determines the display form of location node 70, departure marker 81, and arrival marker 82 displayed on the screen as follows.

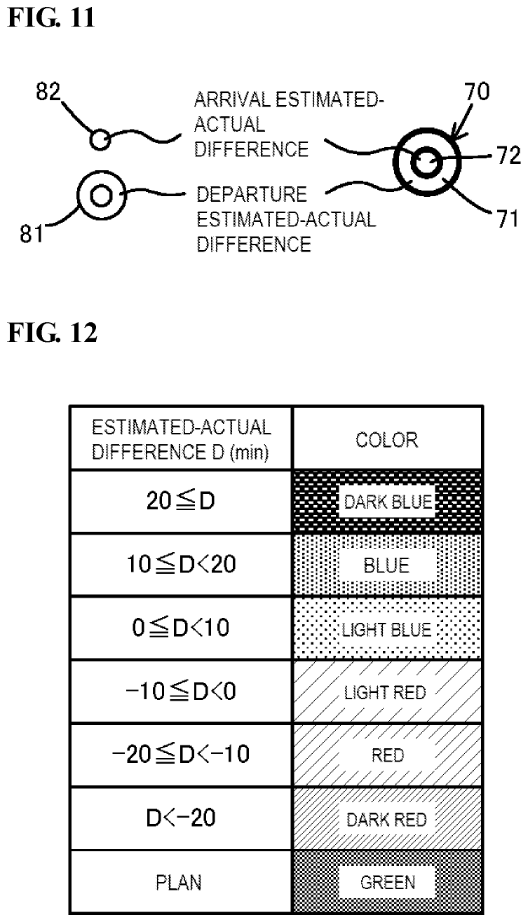

FIG. 11 is a diagram showing the correspondence of location node 70 to departure marker 81 and arrival marker 82. The departure estimated-actual difference is indicated by the display form of departure marker 81 and the display form of a first image 71 which is a concentric circle (doughnut shape) of location node 70. The arrival estimated-actual difference is indicated by the display form of arrival marker 82 and the display form of a second image 72 which is the inner circle of location node 70.

FIG. 12 is a diagram showing a display form of a departure estimated-actual difference and an arrival estimated-actual difference. The display form of the departure estimated-actual difference and the arrival estimated-actual difference when the estimated-actual difference is 20 minutes or more is dark blue. The display form is blue when the estimated-actual difference is 10 minutes or more and less than 20 minutes. The display form is light blue when the estimated-actual difference is 0 minutes or more and less than 10 minutes. The display form is light red when the estimated-actual difference is −10 minutes or more and less than 0 minute. The display form is red when the estimated-actual difference is −20 minutes or more and less than −10 minutes. The display form is dark red when the estimated-actual difference is less than −20 minutes. The display form corresponding to the travel plan is green.

That is, in the image shown in FIG. 8 which is displayed before vehicle 7 departs from the base, location node 70, departure marker 81, and arrival marker 82 are colored in green.

In the image shown in FIG. 9 which is displayed after vehicle 7 has departed from the base, first image 71 of location node 70 corresponding to the delivery center, first image 71 and second image 72 of location nodes 70 corresponding to locations X1, X2, and X3, and second image 72 of location node 70 corresponding to location X4 are colored in a color corresponding to the estimated-actual difference. Further, first image 71 of location node 70 corresponding to location X4, first image 71 and second image 72 of location nodes 70 corresponding to locations X5 and X6, respectively, and second image 72 of location node 70 corresponding to the delivery center are colored in green.

In addition, departure markers 81 and arrival markers 82 in the upper parts of estimated-actual management diagrams 80 shown in FIGS. 9 and 10 are colored in green, and departure markers 81 and arrival markers 82 in the lower parts are colored in colors corresponding to the estimated-actual differences.

Although the images displayed on manager terminal 5 have been described with reference to FIGS. 8 to 10, display processing unit 59 may generate display screen information corresponding to the user who browses the images.

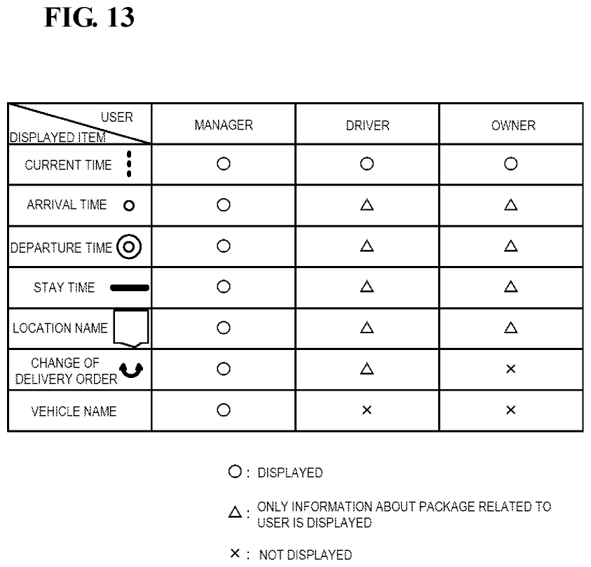

FIG. 13 is a diagram showing information displayed on a terminal used by a user for each user. All information of the current time (current time bar 85), the arrival time (arrival marker 82), the departure time (departure marker 81), the stay time (link 86), the location name (balloon 83), the change of delivery order (change icon 84), and the vehicle name are displayed on the screen of manager terminal 5 used by the manager.

Information other than the vehicle name among information displayed on the screen of manager terminal 5 is displayed on the screen of driver terminal 6 used by the driver. However, only information related to packages delivered by the driver is displayed, and information related to packages not delivered by the driver (for example, arrival times or departure times of destinations of packages not delivered by the driver) is not displayed.

On the screen of sender-side-owner terminal 2 or receiver-side-owner terminal 3 used by the owner, information other than the vehicle name and the change of delivery order among the information displayed on the screen of manager terminal 5 is displayed. However, only information about packages related to the owner is displayed, and information about packages unrelated to the owner (for example, arrival times and departure times of destinations of packages for which the sender-side-owner has not requested delivery) is not displayed. Here, the package related to the owner indicates a package requested to be delivered by the sender-side-owner when the owner is the sender-side-owner, and indicates a package received by the receiver-side-owner when the owner is the receiver-side-owner.

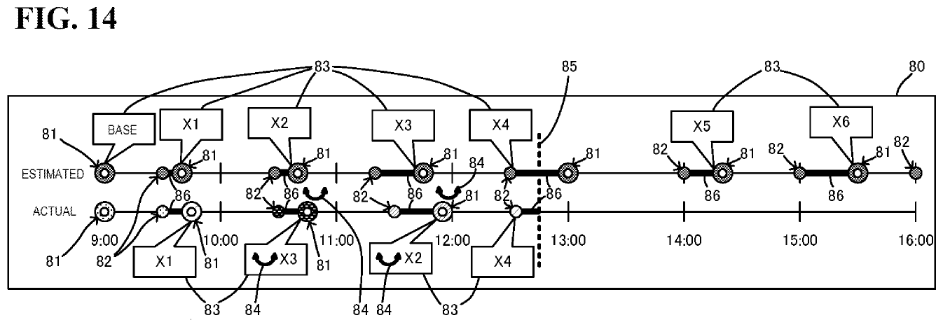

FIG. 14 is a diagram showing an example of an image displayed on driver terminal 6. In the image, estimated-actual management diagram 80 similar to that shown in FIG. 10 is displayed. However, the vehicle name (C4) is not displayed. This is because the driver does not need to have information on the vehicle name of vehicle 7 in which the driver rides for the travel management.

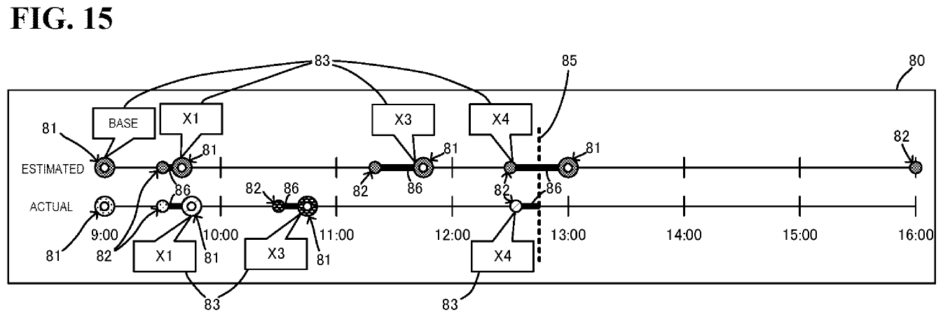

FIG. 15 is a diagram showing an example of an image displayed on sender-side-owner terminal 2 used by the sender-side-owner “A1”. In the image, estimated-actual management diagram 80 similar to that shown in FIG. 10 is displayed. However, only information related to the package requested to be delivered by the sender-side-owner “A1” is displayed. That is, since the destinations of packages P1, P3, and P4 requested to be delivered by the sender-side-owner “A1” are locations X1, X3, and X4, only information on these destinations is displayed. Thus, the sender-side-owner “A1” can efficiently confirm only necessary information. The reason why change icon 84 is not displayed is that it is important for the sender-side-owner “A1” whether the packages have been delivered as planned, and a change in the delivery order is not important.

### [Processing Procedure of Traveling Management Processing]

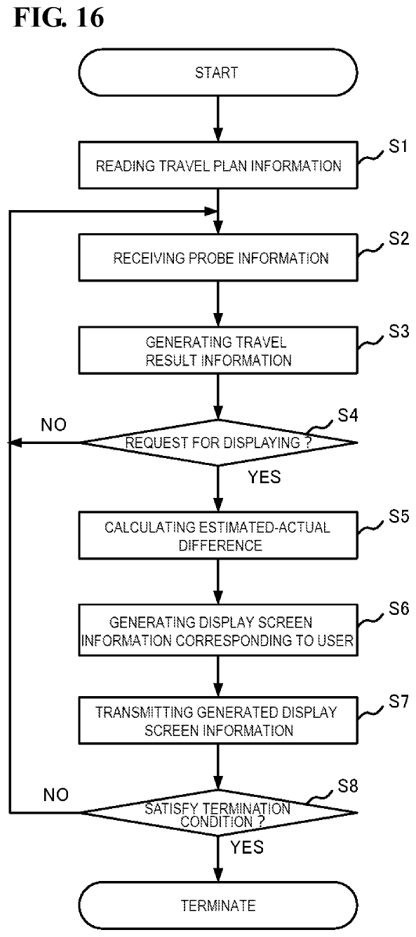

FIG. 16 is a flowchart showing the procedure of the travel management processing of vehicle 7 executed by travel management apparatus 4. Travel plan information acquiring unit 55 reads travel plan information 52 from memory 42 (step S1).

Probe information acquiring unit 56 receives probe information from vehicle 7 via communication I/F unit 40 (step S2).

Travel result information generating unit 57 generates travel result information 53 of vehicle 7 based on the travel plan information and the probe information (step S3).

Estimated-actual difference calculating unit 58 determines whether a request for displaying a screen has been received from the terminal via communication I/F unit 40 (step S4). If the request for displaying has not been received (NO in step S4), the processing of steps S2 and S3 are repeatedly executed.

When the display request is received (YES in step S4), estimated-actual difference calculating unit 58 calculates the estimated-actual difference between the travel plan and the travel result of vehicle 7 based on travel plan information 52 and travel result information 53 (step S5).

Display processing unit 59 generates, based on travel plan information 52, travel result information 53, and the calculated estimated-actual difference, display screen information corresponding to the user who has transmitted the display request (step S6). The user who has transmitted the display request may be determined by, for example, a user ID or the like included in the display request, or may be determined by an identifier of the terminal that has transmitted the display request.

That is, when the user is the manager, display processing unit 59 generates the display screen information for the screen display as shown in FIGS. 9 and 10. When the user is the driver, display processing unit 59 generates display screen information for displaying the image as shown in FIG. 14 on map 60 in the image as shown in FIG. 9. When the user is the owner, display processing unit 59 generates display screen information for displaying the image as shown in FIG. 15 on map 60 in the screen as shown in FIG. 9. However, display processing unit 59 may not display location nodes 70 of the destinations (locations) of the packages not related to the owner on map 60, and may not display links 73 and 74.

Display processing unit 59 transmits the generated display screen information to the terminal of the sender of the display request via communication I/F unit 40 (step S7). The terminal generates an image based on the display screen information and displays the image on the display device.

Processor 43 determines whether or not the termination condition is satisfied (step S8). The termination condition is not limited, but for example, the reception of a termination instruction of the travel management processing may be set as the termination condition, or the elapse of a predetermined time after vehicle 7 completes the delivery may be set as the termination condition.

If the termination condition is not satisfied (NO in step S8), the processing in step S2 and subsequent steps is repeatedly executed. If the termination condition is satisfied (YES in step S8), travel management apparatus 4 terminates the travel management processing.

According to the embodiment of the present disclosure, the travel plan and the travel result are displayed on the display device in association with the time axis. Thus, the user who sees the image of the display device can intuitively recognize the magnitude of the delay time from the travel plan, compared to the case where the time difference is displayed as a numerical value as in PTL 1. Further, a future travel plan is also displayed. For example, the user can intuitively recognize that an influence on the future travel plan is large when the delay time is large. Therefore, the user can easily recognize the degree of influence of the arrival or departure delay at the location on the future travel plan by the display on the display device.

Further, change icon 84 is displayed in association with the time axis. Therefore, the user can easily recognize the change of order in which the plurality of locations are visited. Accordingly, the user can easily identify the cause of the arrival or departure delay at the location.

In addition, arrival marker 82 indicating arrival estimated-actual difference is displayed. Arrival marker 82 has a display correspondence corresponding to the arrival estimated-actual difference. Therefore, the user can visually recognize the arrival estimated-actual difference.

Further, departure marker 81 indicating departure estimated-actual difference is displayed. Departure marker 81 has a display correspondence corresponding to departure estimated-actual difference. Therefore, the user can visually recognize the departure estimated-actual difference.

The display device used by the owner is caused to display the travel plan and the travel result to the destinations of the packages related to the owner, and is not caused to display the travel plan and the travel result to destinations of packages unrelated to the owner. Thus, since it is possible to prevent the sender-side-owner of the package from viewing the travel plan and the travel result related to the packages that are not delivered from the sender-side-owner, the privacy or personal information of users other than the sender-side-owner can be protected. In addition, since it is possible to prevent the receiver-side-owner of the package from viewing the travel plan and the travel result related to the packages that are not delivered to the receiver-side-owner, the privacy or personal information of users other than the receiver-side-owner can be protected.

Further, the vehicle name is displayed on the display device used by the manager of vehicle 7 in association with the display position of at least one of the travel plan and the travel result. Thus, the manager can accurately recognize the degree of influence of the delay of arrival or departure at the location on the future travel plan for each vehicle 7.

Further, the display is performed in consideration of the travel result up to the current time. Thus, the user can easily recognize the degree of influence of the arrival or departure delay at the location on the future travel plan in real time.

Further, the travel plan until the completion of the travel of vehicle 7 to the plurality of locations is displayed. Thus, the user can intuitively recognize the degree of influence of the arrival or departure delay at the location on the completion of the travel plan, and can easily determine whether or not the travel plan can be realized.

### Modification

In the above embodiment, the travel management system for vehicles for joint delivery of the packages has been described. However, the present disclosure is also applicable to a rideshare system in which a plurality of persons is sent from departure places to destinations in a shared manner.

For example, the package is considered as a passenger of vehicle 7, the location is considered as a departure place or a destination of the passenger, and the sender-side-owner and the receiver-side-owner are considered as the passenger, so that the delivery plan and the delivery result of the passenger can be displayed in estimated-actual management diagram 80.

Thus, the user can easily recognize the degree of influence of the arrival or departure delay at the location on the future travel plan.

### [Supplementary Notes]

A part or all of the components constituting travel management apparatus 4 may be configured by a semiconductor device such as one or more system LSI.

The computer program may be recorded in a computer-readable non-transitory recording medium, for example, an HDD, a CD-ROM, a semiconductor memory, or the like, and may be distributed. The computer program may be distributed by being transmitted via an electric communication line, a wireless or wired telecommunication circuit, a network represented by the Internet, a data-broadcasting network, or the like. Travel management apparatus 4 may be implemented by a plurality of computers or a plurality of processors.

Further, some or all of the functions of travel management apparatus 4 may be provided by cloud computing.

The embodiments disclosed herein are to be considered in all respects as illustrative and not restrictive. The scope of the present disclosure is defined by the claims rather than the foregoing description, and is intended to include all modifications within the scope and meaning equivalent to the claims.

### REFERENCE SIGNS LIST

1 travel management system
2 sender-side-owner terminal
3 receiver-side-owner terminal
4 travel management apparatus
5 manager terminal
6 driver terminal
7 vehicle
8 network
40 communication I/F unit
41 input/output I/F unit
42 memory
43 processor
44 bus
51 map information
52 travel plan information
53 travel result information
54 computer program
55 travel plan information acquiring unit
56 probe information acquiring unit
57 travel result information generating unit
58 estimated-actual difference calculating unit
59 display processing unit
60 map
70 location node
71 first image
72 second image
73, 74, 86 link
80 estimated-actual management diagram
81 departure marker
82 arrival marker
83 balloon
84 change icon
85 current time bar

1. A travel management method comprising:
acquiring travel plan information of a vehicle for a plurality of locations;
acquiring travel result information of the vehicle for the plurality of locations; and
causing, based on the travel plan information and the travel result information, a display device to display, in association with a time axis, a travel plan of the vehicle in a time period including times before and after a predetermined time and a travel result of the vehicle by the predetermined time.

2. The travel management method according to claim 1, wherein the causing includes causing the display device to display, in association with the time axis, information indicating a change of order in which the plurality of locations is visited.

3. The travel management method according to claim 1, further comprising:
generating, based on the travel plan information and the travel result information, an arrival estimated-actual difference which is a difference between an estimated arrival time and an actual arrival time of the vehicle at each of the locations, wherein
the causing includes causing the display device to display image information indicating the arrival estimated-actual difference.

4. The travel management method according to claim 1, further comprising:
generating, based on the travel plan information and the travel result information, a departure estimated-actual difference which is a difference between an estimated departure time and an actual departure time of the vehicle at each of the locations, wherein
the causing includes causing the display device to display image information indicating the departure estimated-actual difference.

5. The travel management method according to claim 1, wherein the causing includes causing the display device, the display device being used by an owner of a package transported by the vehicle, to display the travel plan and the travel result for a location which is a destination of a package related to the owner among the plurality of locations, and not to display the travel plan and the travel result for the location which is a destination of a package unrelated to the owner among the plurality of locations.

6. The travel management method according to claim 1, wherein the causing includes causing the display device, the display device being used by a manager of the vehicle, to display identification information of the vehicle in association with a display position of at least one of the travel plan or the travel result.

7. The travel management method according to claim 1, wherein the predetermined time is a current time.

8. The travel management method according to claim 1, wherein the causing includes causing the display device to display the travel plan for completing travel of the vehicle to the plurality of locations.

9. A travel management apparatus comprising:
a travel management information acquiring circuit configured to acquire travel plan information of a vehicle for a plurality of locations;
a travel result information acquiring circuit configured to acquire travel result information of the vehicle for the plurality of locations; and
a display processing circuit configured to cause, based on the travel plan information and the travel result information, a display device to display, in association with a time axis, a travel plan of the vehicle in a time period including times before and after a predetermined time and a travel result of the vehicle by the predetermined time.

10. A non-transitory processor-readable medium storing a computer program for causing a computer to function as:
a travel management information acquiring circuit configured to acquire travel plan information of a vehicle for a plurality of locations;
a travel result information acquiring circuit configured to acquire travel result information of the vehicle for the plurality of locations; and
a display processing circuit configured to cause, based on the travel plan information and the travel result information, a display device to display, in association with a time axis, a travel plan of the vehicle in a time period including times before and after a predetermined time and a travel result of the vehicle by the predetermined time.

11. The travel management method according to claim 2, further comprising:
generating, based on the travel plan information and the travel result information, an arrival estimated-actual difference which is a difference between an estimated arrival time and an actual arrival time of the vehicle at each of the locations, wherein
the causing includes causing the display device to display image information indicating the arrival estimated-actual difference.

12. The travel management method according to claim 2, further comprising:
generating, based on the travel plan information and the travel result information, a departure estimated-actual difference which is a difference between an estimated departure time and an actual departure time of the vehicle at each of the locations, wherein
the causing includes causing the display device to display image information indicating the departure estimated-actual difference.

13. The travel management method according to claim 3, further comprising:
generating, based on the travel plan information and the travel result information, a departure estimated-actual difference which is a difference between an estimated departure time and an actual departure time of the vehicle at each of the locations, wherein
the causing includes causing the display device to display image information indicating the departure estimated-actual difference.

14. The travel management method according to claim 2, wherein the causing includes causing the display device, the display device being used by an owner of a package transported by the vehicle, to display the travel plan and the travel result for a location which is a destination of a package related to the owner among the plurality of locations, and not to display the travel plan and the travel result for the location which is a destination of a package unrelated to the owner among the plurality of locations.

15. The travel management method according to claim 3, wherein the causing includes causing the display device, the display device being used by an owner of a package transported by the vehicle, to display the travel plan and the travel result for a location which is a destination of a package related to the owner among the plurality of locations, and not to display the travel plan and the travel result for the location which is a destination of a package unrelated to the owner among the plurality of locations.

16. The travel management method according to claim 4, wherein the causing includes causing the display device, the display device being used by an owner of a package transported by the vehicle, to display the travel plan and the travel result for a location which is a destination of a package related to the owner among the plurality of locations, and not to display the travel plan and the travel result for the location which is a destination of a package unrelated to the owner among the plurality of locations.

17. The travel management method according to claim 2, wherein the causing includes causing the display device, the display device being used by a manager of the vehicle, to display identification information of the vehicle in association with a display position of at least one of the travel plan or the travel result.

18. The travel management method according to claim 3, wherein the causing includes causing the display device, the display device being used by a manager of the vehicle, to display identification information of the vehicle in association with a display position of at least one of the travel plan or the travel result.

19. The travel management method according to claim 4, wherein the causing includes causing the display device, the display device being used by a manager of the vehicle, to display identification information of the vehicle in association with a display position of at least one of the travel plan or the travel result.

20. The travel management method according to claim 5, wherein the causing includes causing the display device, the display device being used by a manager of the vehicle, to display identification information of the vehicle in association with a display position of at least one of the travel plan or the travel result.
